(19) United States
(12) Patent Application Publication
(10) Pub. No.: US 2026/0370097 A1
(43) Pub. Date: Nov. 19, 2026

(54) ELECTRIC COMPRESSOR FOR VEHICLE

(71) Applicant: SANDEN CORPORATION, Gunma (JP)

(72) Inventors: Tomosato IDA, Gunma (JP); Shunsuke KANEKO, Gunma (JP)

(21) Appl. No.: 19/103,271

(22) PCT Filed: Jul. 27, 2023
(86) PCT No.: PCT/JP2023/027527

§ 371 Date: Feb. 12, 2025

(30) Foreign Application Priority Data
Aug. 24, 2022 (JP) 2022-133211

(51) Int. Cl. H02K 11/33; H02M 1/00; H02M 1/32; H02M 7/00

(52) U.S. Cl. CPC H02K 11/33; H02M 1/0009; H02M 1/327; H02M 7/003

(57) ABSTRACT

There is provided a vehicle electric compressor capable of stopping a switching element of an inverter circuit from being damaged by capacitor discharge control of discharging a capacitor. In a vehicle electric compressor 1, a controller 55 of an inverter device 5 that supplies power to an electric motor that drives a compression mechanism performs capacitor discharge control of discharging the charges accumulated in a first capacitor 51 and a second capacitor 21 by controlling switching elements Q1, Q4, and Q6 among a plurality of switching elements Q1 to Q6 of an inverter circuit 50. The controller 55 is configured to control the switching elements Q1, Q4, and Q6 such that a current flowing through the switching elements Q1, Q4, and Q6 becomes equal to or less than an allowable current according to a switching element temperature.

### TECHNICAL FIELD

The present invention relates to a vehicle electric compressor mounted on a vehicle.

### BACKGROUND ART

An in-vehicle electric compressor described in Patent Literature 1 is known as an example of a vehicle electric compressor. The in-vehicle electric compressor described in Patent Literature 1 is configured such that a current sensor detects non-energization across a battery as a DC power source provided in a vehicle and an inverter circuit (that a connector connecting the battery to the inverter circuit is disconnected), and when the non-energization is detected, a switching element of the inverter circuit is controlled to start discharging a capacitor.

### CITATION LIST

### Patent Literature

Patent Literature 1: JP-A-2018-166364

### SUMMARY OF INVENTION

### Problems to be Solved by Invention

However, the in-vehicle electric compressor described in Patent Literature 1 has the following problems.

When non-energization is detected and discharge of the capacitor is started even though the battery and the inverter circuit are in the energized state due to erroneous detection of the current sensor or the like, a current continues to flow through the switching element while a high voltage is maintained, and heat generation of the switching element increases, which may cause thermal breakdown of the switching element.

Not only discharge of the electric compressor side capacitor but also discharge of the vehicle side capacitor may be requested. The vehicle-side capacitor generally has a larger capacitance than the electric compressor-side capacitor has. Therefore, in response to such a request, the current (that is, heat generation of the switching element) flowing through the switching element becomes larger than expected, and the switching element may be thermally broken.

An object of the present invention is to provide a vehicle electric compressor capable of stopping a switching element of an inverter circuit from being damaged (thermal breakdown or the like) by capacitor discharge control of discharging a capacitor.

### Solution to Problems

According to an aspect of the present invention, there is provided a vehicle electric compressor including, in a housing, an electric motor, a compression mechanism driven by the electric motor, and an inverter device that supplies power to the electric motor. This vehicle electric compressor includes: an inverter circuit that includes a plurality of switching elements disposed between a positive bus bar and a negative bus bar connected to a DC power source of a vehicle, the inverter circuit converting DC power from the DC power source of the vehicle into AC power and supplying the AC power to a coil of the electric motor; a capacitor connected between the positive bus bar and the negative bus bar, the capacitor being disposed closer to the DC power source of the vehicle from the inverter circuit; a temperature detector that detects a temperature of the plurality of switching elements or a temperature in a vicinity of the plurality of switching elements; and a controller that controls at least some of the plurality of switching elements to perform capacitor discharge control of discharging charges accumulated in the capacitor via the at least some of the switching elements and the coil of the electric motor, the controller being configured to control the at least some switching elements such that a current flowing through the at least some switching elements becomes equal to or less than an allowable current according to a temperature detected by the temperature detector.

### Effects of Invention

According to the present invention, it is possible to provide a vehicle electric compressor capable of stopping a switching element of an inverter circuit from being damaged (thermal breakdown or the like) by capacitor discharge control of discharging a capacitor.

### BRIEF DESCRIPTION OF DRAWINGS

FIG. 1 is a schematic longitudinal sectional view of a vehicle electric compressor according to an embodiment.

FIG. 2 is a circuit configuration diagram of the vehicle electric compressor according to the embodiment.

FIG. 3 is a diagram showing an example of a capacitor discharge circuit.

FIG. 4 is a flowchart showing an example of capacitor discharge control.

FIG. 5 is a flowchart showing an example of capacitor discharge control.

FIG. 6 is a diagram showing an example of a target discharge current setting map.

FIG. 7 is a diagram showing an example of a duty ratio of a switching element to be set.

FIG. 8 is a diagram showing another example of the duty ratio of the switching element to be set.

### DESCRIPTION OF EMBODIMENTS

In the following, an embodiment of the present invention will be described with reference to the accompanying drawings.

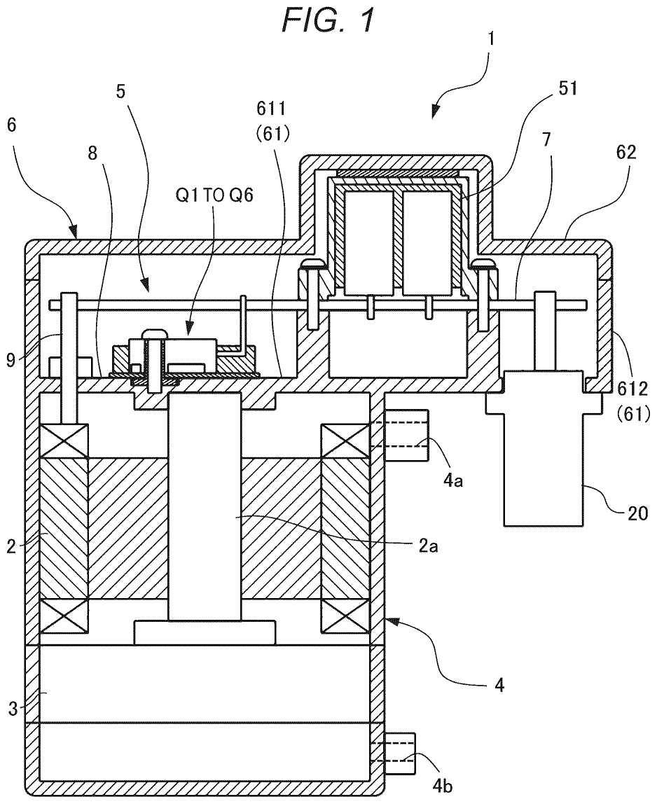

FIG. 1 is a schematic longitudinal sectional view of a vehicle electric compressor (in the following, simply referred to as “electric compressor”) 1 according to an embodiment of the present invention. The electric compressor 1 according to the embodiment is an inverter-integrated electric compressor integrally including an inverter device. The electric compressor 1 is mounted on a vehicle to constitute a part of a refrigerant circuit of a vehicle air conditioner, and can be configured to compress and discharge a refrigerant.

Referring to FIG. 1, the electric compressor 1 includes an electric motor 2, a compression mechanism 3 that is driven by the electric motor to compress a refrigerant, a main housing 4 that accommodates the electric motor 2 and the compression mechanism 3, an inverter device 5 that supplies power to the electric motor 2, and an inverter housing 6 that accommodates the inverter device 5. The main housing 4 and the inverter housing 6 constitute a housing of the electric compressor 1. That is, the electric compressor 1 includes the electric motor 2, the compression mechanism 3, and the inverter device 5 in the housing.

The electric motor 2 is, for example, a three-phase synchronous motor (brushless DC motor). The compression mechanism 3 is, for example, a scroll compression mechanism. The electric motor 2 and the compression mechanism 3 are disposed in series in the main housing 4 in the axial direction of an output shaft 2a of the electric motor 2, and the output shaft 2a of the electric motor 2 is connected to the compression mechanism 3 (an orbiting scroll in the case of a scroll compression mechanism).

The inverter device 5 includes a circuit board 7 on which various electronic components are mounted. The circuit board 7 is attached to the inverter housing 6 by a plurality of fixing members.

The inverter housing 6 is provided integrally with the main housing 4. The inverter housing 6 is disposed on one end side of the main housing 4 in the axial direction, specifically, on the side opposite to the compression mechanism 3 across the electric motor 2. In the present embodiment, the inverter housing 6 includes a housing main body 61 formed integrally with the main housing 4, and a cover member 62 detachable from the housing main body 61.

The housing main body 61 has a bottom wall 611 and a peripheral wall 612 rising from a peripheral edge of the bottom wall 611 and defining an opening facing the bottom wall 611. The cover member 62 is attached to the housing main body 61 so as to close the opening of the housing main body 61. A part of the bottom wall 611 of the housing main body 61 (which is also the bottom wall of the inverter housing 6) constitutes a partition wall 8 that partitions the inside of the main housing 4 and the inside of the inverter housing 6. The electric motor 2 and the inverter device 5 are electrically connected to each other via a power supply line 9 extending through the partition wall 8 in an airtight and liquid-tight state.

In a portion of the main housing 4 on the partition wall 8 side, a refrigerant inflow port 4a through which a refrigerant from the outside flows into the main housing 4 is formed. The refrigerant flowing into the main housing 4 from the refrigerant inflow port 4a flows through the main housing 4 (gap of the electric motor 2) to reach the compression mechanism 3. The compression mechanism 3 is driven by the electric motor 2 to compress and discharge the refrigerant.

The refrigerant flowing from the refrigerant inflow port 4a into the main housing 4 is, for example, a low-temperature and low-pressure refrigerant that has passed through an expansion valve, an evaporator, and the like in a refrigerant circuit of the vehicle air conditioner. Therefore, the partition wall 8 and the electric motor 2 can be cooled by the refrigerant flowing into the main housing 4 from the refrigerant inflow port 4a. The refrigerant flowing in the main housing 4 is compressed by the compression mechanism 3 to become a high-temperature and high-pressure refrigerant, and is discharged from the compression mechanism 3. The (high-temperature and high-pressure) refrigerant discharged from the compression mechanism 3 flows out from a refrigerant outlet 4b formed in the main housing 4.

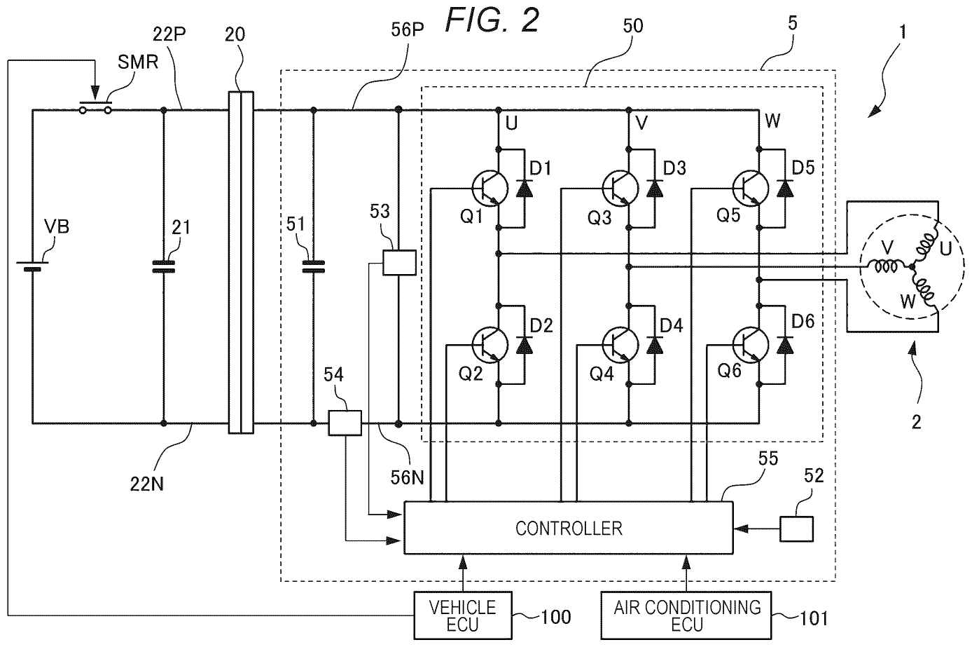

FIG. 2 is a circuit configuration diagram of the electric compressor 1.

Referring to FIG. 2, the electric compressor 1 is connected to an in-vehicle battery (in the following, simply referred to as a “battery”) VB as a DC power source of the vehicle via a connector 20. Then, DC power is supplied from the battery VB to the electric compressor 1 via the connector 20, more specifically, to an inverter circuit 50 described later of the inverter device 5.

The inverter device 5 of the electric compressor 1 includes the inverter circuit 50, a first capacitor 51, a temperature detector 52, a voltage detector 53, a current detector 54, and a controller 55. At least a part of these components is mounted on the circuit board 7. Here, although one circuit board 7 is shown in FIG. 1, the present invention is not limited to this, and the inverter device 5 may include a plurality of circuit boards, and the inverter circuit 50, the first capacitor 51, and the like constituting the inverter device 5 may be dispersedly arranged on the plurality of circuit boards.

The inverter circuit 50 is connected to the battery VB via the connector 20 and a system main relay SMR. Specifically, the inverter circuit 50 has a positive bus bar 56P and a negative bus bar 56N, the positive bus bar 56P of the inverter circuit 50 is connected to the positive terminal of the battery VB via the connector 20 and the system main relay SMR, and the negative bus bar 56N of the inverter circuit 50 is connected to the negative terminal of the battery VB via the connector 20.

In the present embodiment, the system main relay SMR is configured to be closed by an ON operation of a start button of the vehicle and to be opened by an OFF operation of the start button of the vehicle by a control device (vehicle ECU) 100 of the vehicle. When the system main relay SMR is closed, the battery VB and (the inverter device 5 of) the electric compressor 1 are electrically connected, and when the system main relay SMR is opened, the battery VB and (the inverter device 5 of) the electric compressor 1 are electrically disconnected.

The inverter circuit 50 includes a plurality of (here, six) switching elements Q1 to Q6 arranged between the positive bus bar 56P and the negative bus bar 56N connected to the battery VB, and the same number of (here, six) diodes D1 to D6 as the switching elements Q1 to Q6. Although not specifically limited, the switching elements Q1 to Q6 may be insulated gate bipolar transistors (IGBTs). The inverter circuit 50 is configured to convert DC power from the battery VB into three-phase AC power and supply the three-phase AC power to the electric motor 2 by the switching elements Q1 to Q6 under control (PMW control).

Here, in the present embodiment, the plurality of switching elements Q1 to Q6 is disposed in the inverter housing 6 so as to be in thermal contact with the partition wall 8 (see FIG. 1). Here, the term “in thermal contact with the partition wall 8” means a state in which heat can be exchanged with the partition wall 8, and includes direct contact with the partition wall 8, proximity to the partition wall 8, and indirect contact with the partition wall 8 via a heat exchange member or the like having high thermal conductivity. Therefore, the plurality of switching elements Q1 to Q6 can be cooled via the partition wall 8 by the (low-temperature) refrigerant flowing into the main housing 4.

The inverter circuit 50 will be further described. The inverter circuit 50 includes a U-phase arm, a V-phase arm, and a W-phase arm provided in parallel between the positive bus bar 56P and the negative bus bar 56N. Two switching elements Q1 and Q2 are connected in series to the U-phase arm, and the diodes DI and D2 are connected in anti-parallel to the switching elements Q1 and Q2, respectively. Two switching elements Q3 and Q4 are connected in series to the V-phase arm, and the diodes D3 and D4 are connected in anti-parallel to the switching elements Q3 and Q4, respectively. Two switching elements Q5 and Q6 are connected in series to the W-phase arm, and the diodes D5 and D6 are connected in anti-parallel to the switching elements Q5 and Q6, respectively.

In addition, an intermediate point of each of the U-phase arm, the V-phase arm, and the W-phase arm is connected to the other end of the U-phase coil, the V-phase coil, and the W-phase coil of the electric motor 2, which are star-connected at one end of each of the U-phase arm, the V-phase arm, and the W-phase arm. That is, the intermediate point of the U-phase arm located between the switching elements Q1 and Q2 in the U-phase arm is connected to the U-phase coil, the intermediate point of the V-phase arm located between the switching elements Q3 and Q4 in the V-phase arm is connected to the V-phase coil, and the intermediate point of the V-phase arm located between the switching elements Q5 and Q6 in the W-phase arm is connected to the W-phase coil.

By controlling the ratio of the ON period of the switching elements Q1, Q3, and Q5 on the positive bus bar 56P side and the ratio of the ON period of the switching elements Q2, Q4, and Q6 on the negative bus bar 56N side of each phase arm, i.e., by controlling (PWM controlling) the switching elements Q1 to Q6 at the duty ratio, the inverter circuit 50 can convert the DC power from the battery VB into the three-phase AC power and supply the three-phase AC power to the electric motor 2, and thus the electric motor 2 is driven.

The first capacitor 51 is connected between the positive bus bar 56P and the negative bus bar 56N of the inverter circuit 50. The first capacitor 51 is disposed closer to the battery VB from the inverter circuit 50, i.e., disposed between the inverter circuit 50 and the connector 20. The first capacitor 51 is a smoothing capacitor that smooths DC power supplied from the battery VB to the inverter circuit 50.

The temperature detector 52 detects temperatures of the switching elements Q1 to Q6 or temperatures near the switching elements Q1 to Q6 (in the following, these are simply collectively referred to as “switching element temperatures”.)

The voltage detector 53 is disposed between the inverter circuit 50 and the first capacitor 51, and detects a potential difference between the positive bus bar 56P and the negative bus bar 56N between the inverter circuit 50 and the first capacitor 51.

The current detector 54 detects a current flowing through the electric motor 2. In the present embodiment, the current detector 54 is disposed on the negative bus bar 56N between the inverter circuit 50 and the first capacitor 51. However, the present invention is not limited to this, and the current detector 54 may be disposed on the positive bus bar 56P between the inverter circuit 50 and the first capacitor 51.

The controller 55 is configured to control (PWM control) the switching elements Q1 to Q6 in order to drive the electric motor 2 and thus the compression mechanism 3 based on an operation command from a control device (air conditioning ECU) 101 of the vehicle air conditioner.

In addition, the controller 55 is configured to perform control of discharging the capacitor (in the following, referred to as “capacitor discharge control”) when receiving a capacitor discharge command from the vehicle ECU 100. In the present embodiment, the vehicle ECU 100 is configured to output the capacitor discharge command to the controller 55 under the condition that at least a start button of the vehicle is turned OFF (that is, the system main relay SMR has been opened.).

Here, in the present embodiment, in addition to the first capacitor 51, a second capacitor 21 connected in parallel to the battery VB is provided on the battery VB side of the connector 20. The second capacitor 21 is connected between a positive-side wire 22P that connects the positive terminal of the battery VB to the positive bus bar 56P of the inverter circuit 50 via the connector 20 and a negative-side wire 22N that connects the negative terminal of the battery VB to the negative bus bar 56N of the inverter circuit 50 via the connector 20. Similarly to the first capacitor 51, the second capacitor 21 has a function of smoothing DC power supplied from the battery VB to the inverter circuit 50.

Therefore, in the present embodiment, the controller 55 is configured to discharge the first capacitor 51 and the second capacitor 21 by the capacitor discharge control. That is, the controller 55 is configured to discharge the charge accumulated in the second capacitor 21 in addition to discharging the charge accumulated in the first capacitor 51 by performing the capacitor discharge control. Here, the first capacitor 51 is a capacitor on the electric compressor side, and the second capacitor 21 is a capacitor on the vehicle side.

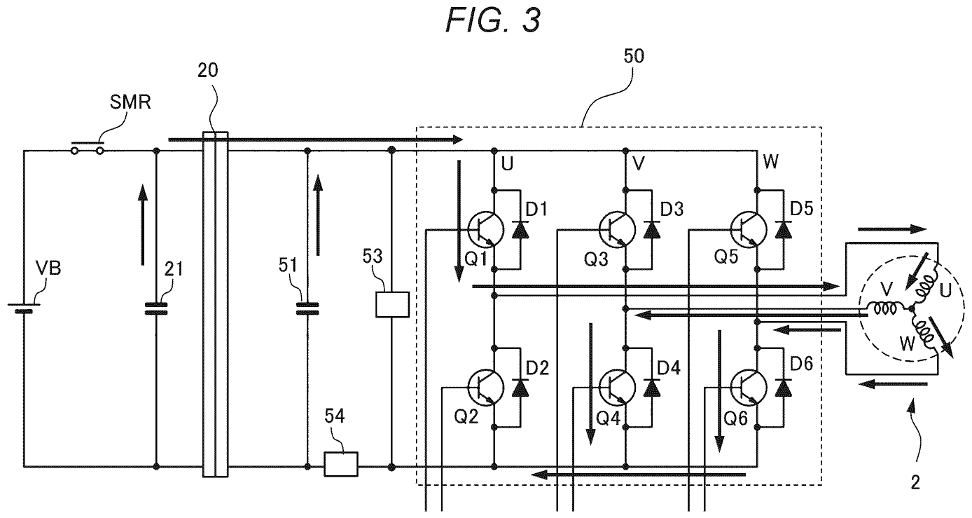

Specifically, when receiving the capacitor discharge command, the controller 55 controls (turns on) at least some of the switching elements among the plurality of switching elements Q1 to Q6, here, the switching elements Q1, Q4, and Q6 to energize the first capacitor 51 and the second capacitor 21 and the coil (U-phase coil, V-phase coil, and W-phase coil) of the electric motor 2. As a result, a capacitor discharge circuit including the switching elements Q1, Q4, and Q6 and the coil of the electric motor 2 is generated, and as indicated by arrows in FIG. 3, the charge accumulated in the first capacitor 51 and the charge accumulated in the second capacitor 21 are discharged via the switching elements Q1, Q4, and Q6 and the coil (U-phase coil, V-phase coil, and W-phase coil) of the electric motor 2.

The capacitor discharge control performed by the controller 55 will be further described.

In the present embodiment, when receiving the capacitor discharge command, the controller 55 starts monitoring the switching element temperature detected by the temperature detector 52, monitoring the voltage detected by the voltage detector 53, and monitoring the current detected by the current detector 54. Here, the potential difference detected by the voltage detector 53 is a potential difference between the positive bus bar 56P and the negative bus bar 56N, and corresponds to a voltage (capacitor voltage) across the terminals of the first capacitor 51 and the second capacitor 21. The current detected by current detector 54 corresponds to the discharge current of the first capacitor 51 and/or the second capacitor 21 when the capacitor discharge circuit is generated. Therefore, in the following, the potential difference detected by the voltage detector 53 may be referred to as a “capacitor voltage equivalent value”, and the current detected by the current detector 54 may be referred to as a “capacitor discharge current”. The controller 55 determines whether the capacitor discharge control is necessary based on the capacitor voltage equivalent value detected by the voltage detector 53. In the case where the capacitor discharge control is necessary, the controller 55 sets a target discharge current based on the switching element temperature detected by the temperature detector 52, sets a duty ratio of the switching elements Q1, Q4, and Q6 based on the set target discharge current and the capacitor discharge current detected by the current detector 54, and controls the switching elements Q1, Q4, and Q6 with the set duty ratio.

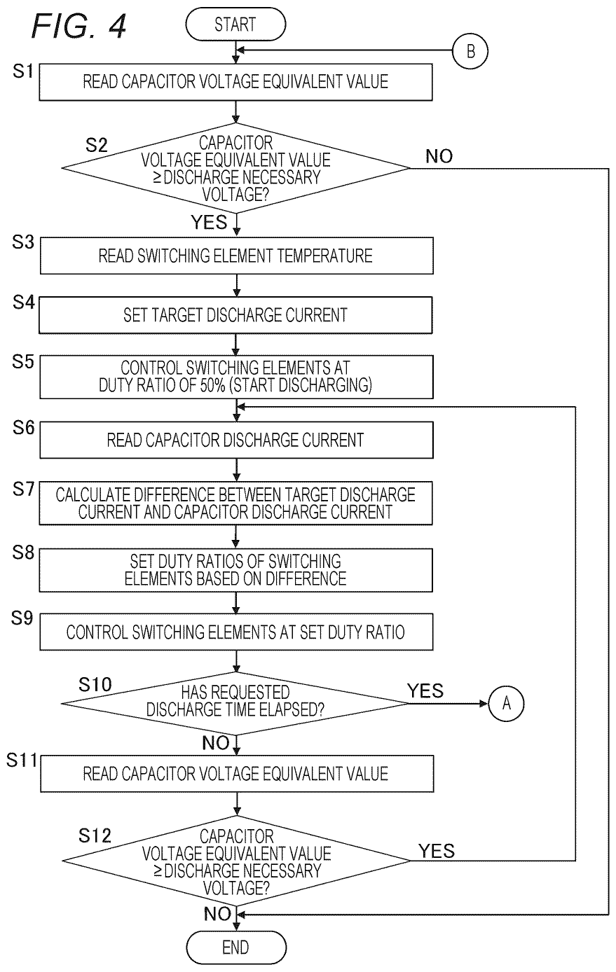

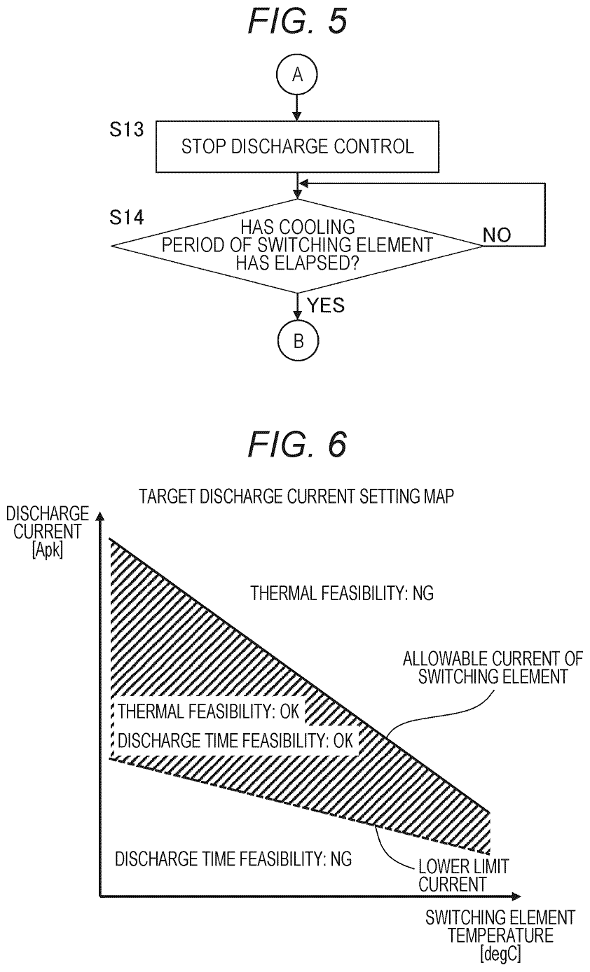

FIGS. 4 and 5 are flowcharts showing an example of the capacitor discharge control performed by the controller 55. This flowchart is started when the controller 55 receives the capacitor discharge command.

In Step S1, the controller 55 reads the potential difference detected by the voltage detector 53, i.e., the capacitor voltage equivalent value.

In Step S2, the controller 55 determines whether the read capacitor voltage equivalent value is equal to or higher than a discharge necessary voltage which is a reference value requiring the capacitor discharge control. In the case where the read capacitor voltage equivalent value is the discharge necessary voltage or more, the controller 55 proceeds to the processing of Step S3, and in the case where the read capacitor voltage equivalent value is less than the discharge necessary voltage, the controller 55 ends this flow.

In Step S3, the controller 55 reads the switching element temperature detected by the temperature detector 52.

In Step S4, the controller 55 sets the target discharge current based on the read switching element temperature. The controller 55 sets the target discharge current as follows.

In the present embodiment, the controller 55 has a target discharge current setting map as shown in FIG. 6. In the target discharge current setting map, the X-axis represents the switching element temperature, and the Y-axis represents a discharge current value (=current flowing through the switching element=phase current value of the electric motor 2). In addition, a solid line in FIG. 6 indicates an allowable current of the switching element, which is a maximum current that the switching element is not thermally broken even when flowing in the switching element, and a broken line in FIG. 6 indicates a lower limit current necessary to complete the discharge of the first capacitor 51 and the second capacitor 21 within a preset requested discharge time (it is not necessary to complete the process, and the process may be substantially completed.) Here, the allowable current and the lower limit current are set in consideration of temperature characteristics (specifically resistance fluctuation) of the capacitor discharge circuit generated to discharge the charge accumulated in the first capacitor 51 and the charge accumulated in the second capacitor 21, i.e., the capacitor discharge circuit including the switching elements Q1, Q4, and Q6 and the coil of the electric motor 2.

Then, based on the read switching element temperature, the controller 55 sets, as a target discharge current, a current equal to or less than the allowable current and equal to or more than the lower limit current, i.e., a current within hatching in FIG. 6. That is, the controller 55 basically sets a target discharge current having a higher current value as the switching element temperature is lower. Although not specifically limited, in the present embodiment, in order to suppress heat generation of the switching elements Q1, Q4, and Q6 as much as possible, the controller 55 sets a current having a current value relatively close to the lower limit current as a target discharge current based on the switching element temperature.

In Step S5, the controller 55 controls the switching elements Q1, Q4, and Q6 at a duty ratio of 50%. As a result, the capacitor discharge circuit is generated, and the capacitor discharge control, i.e., the discharge of the charge accumulated in the first capacitor 51 and the discharge of the charge accumulated in the second capacitor 21 are started.

In Step S6, the controller 55 reads the current detected by the current detector 54, i.e., the capacitor discharge current.

In Step S7, the controller 55 calculates a difference between the set target discharge current and the read capacitor discharge current.

In Step S8, the controller 55 sets the duty ratios of the switching elements Q1, Q4, and Q6 based on the calculated difference.

In Step S9, the controller 55 controls the switching elements Q1, Q4, and Q6 at the set duty ratio. As a result, the charge accumulated in the first capacitor 51 and the charge accumulated in the second capacitor 21 are discharged in a state where the current flowing through the switching elements Q1, Q4, and Q6 is limited to the allowable current or less.

In Step S10, the controller 55 determines whether the requested discharge time has elapsed since the reception of the capacitor discharge command or since the start of discharge. In the case where the requested discharge time has not elapsed, the controller 55 proceeds to the processing of Step S11. On the other hand, when the requested discharge time has elapsed, the controller 55 proceeds to the processing of Step S13 (FIG. 5).

In Step S11, the controller 55 reads the potential difference detected by the voltage detector 53, i.e., the capacitor voltage equivalent value.

In Step S12, the controller 55 determines whether the read capacitor voltage equivalent value is equal to or higher than the discharge necessary voltage. In the case where the read capacitor voltage equivalent value is equal to or more than the discharge necessary voltage, the controller 55 returns to the processing of Step S6, and in the case where the read capacitor voltage equivalent value is less than the discharge necessary voltage, the controller 55 ends this flow.

In Step S13, the controller 55 stops the capacitor discharge control.

In Step S14, the controller 55 determines whether a preset cooling period of the switching element has elapsed since the capacitor discharge control was stopped. Then, when the cooling period of the switching element has elapsed, the controller 55 returns to the processing of Step S1.

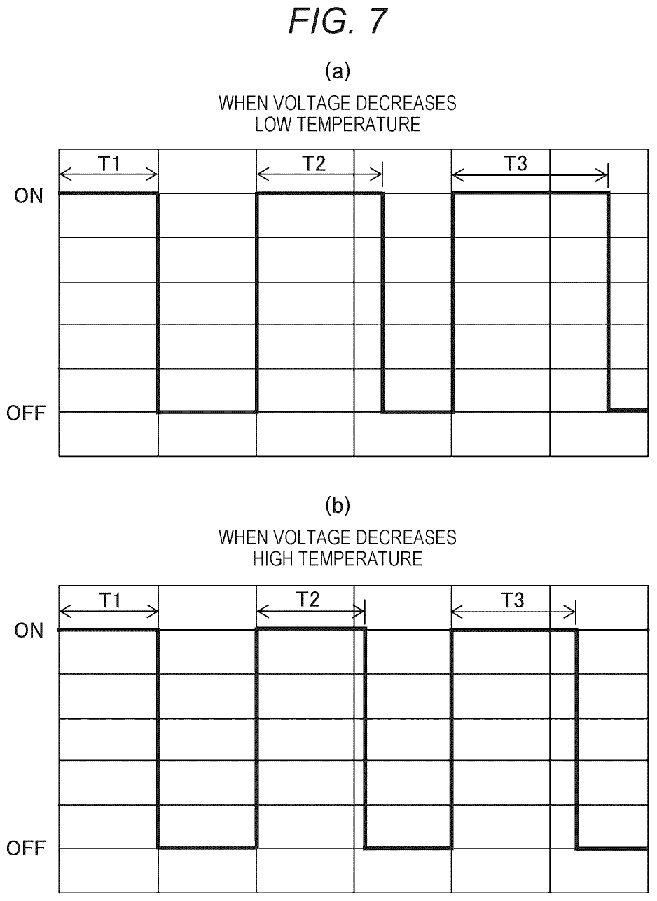

FIG. 7 is a diagram showing an example of duty ratios of the switching elements Q1, Q4, and Q6 set by the controller 55. FIG. 7(a) shows the case where the switching element temperature is low, and FIG. 7(b) shows the case where the switching element temperature is high.

When the capacitor discharge command is input to the controller 55, the system main relay SMR is normally opened, and the first capacitor 51 and the second capacitor 21 are electrically disconnected from the battery VB. Therefore, the capacitor voltage equivalent value detected by the voltage detector 53 decreases as the first capacitor 51 and the second capacitor 21 are discharged. In other words, the capacitor voltage equivalent value gradually decreases with the lapse of time from the start of the capacitor discharge control until the requested discharge time elapses. In addition, when the capacitor voltage equivalent value decreases, the capacitor discharge current detected by the current detector 54 also decreases. Therefore, when the target discharge current is constant, in order to maintain the target discharge current, as shown in FIG. 7(a) and 7(b), the duty ratio set in Step S8 increases as time passes (T1<T2<T3). Note that in the case where the switching element temperature is high, a target discharge current having a lower current value than that in the case where the switching element temperature is low is set (see FIG. 6). Therefore, in the control duty ratio (FIG. 7(b)) in the case where the switching element temperature is high, an increase in the duty ratio is smaller than the duty ratio (FIG. 7(a)) in the case where the switching element temperature is low.

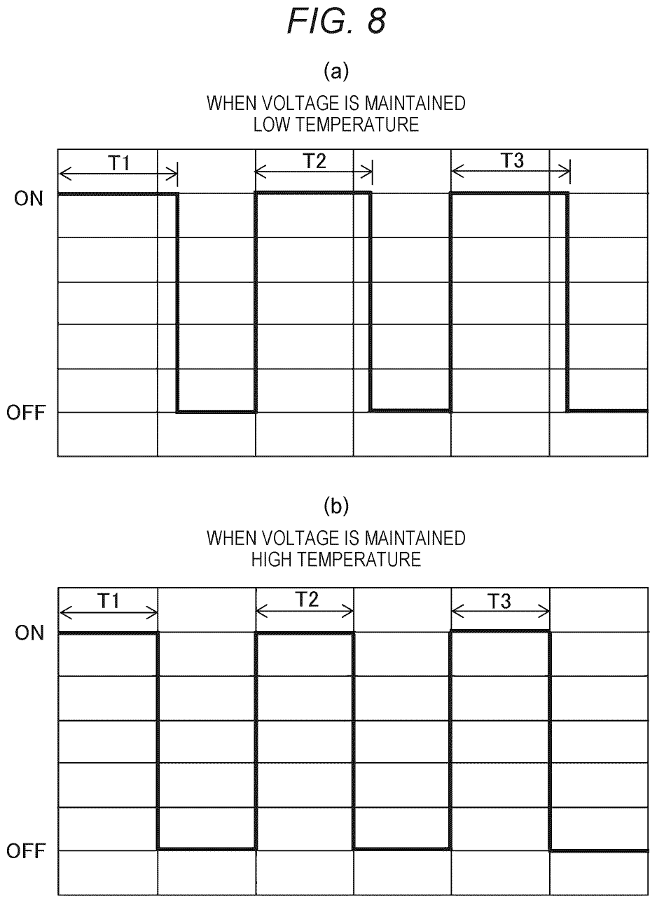

FIG. 8 is a diagram showing another example of the duty ratios of the switching elements Q1, Q4, and Q6 set by the controller 55. FIG. 8(a) shows the case where the switching element temperature is low, and FIG. 8(b) shows the case where the switching element temperature is high.

For some reason, in the case where the capacitor discharge command is input to the controller 55 when the system main relay SMR is closed, in other words, in the case where the capacitor discharge command is erroneously input to the controller 55, the first capacitor 51 and the second capacitor 21 are in a state of being electrically connected to the battery VB. In this case, the potential difference (the capacitor voltage equivalent value) detected by the voltage detector 53 is maintained constant (does not decrease) even after the start of the capacitor discharge control. Therefore, in the case where the target discharge current is constant, a substantially constant duty ratio corresponding to the target discharge current is set in Step S8 (T1≈T2≈T3) as shown in FIG. 8(a) and 8(b) until the requested discharge time elapses. In the case where the switching element temperature is high, a target discharge current having a current value lower than that in the case where the switching element temperature is low is set. Therefore, the control duty ratio (FIG. 8(b)) in the case where the switching element temperature is high is set to be smaller than the control duty ratio (FIG. 8(a)) in the case where the switching element temperature is low.

As described above, in the present embodiment, when receiving the capacitor discharge command, the controller 55 performs the capacitor discharge control to discharge the first capacitor 51 and the second capacitor 21 via the switching elements Q1, Q4, and Q6 and the coil of the electric motor 2 by controlling the switching elements Q1, Q4, and Q6. At that time, the controller 55 controls the switching elements Q1, Q4, and Q6 such that the current flowing through the switching elements Q1, Q4, and Q6 becomes equal to or less than the allowable current of the switching elements Q1, Q4, and Q6 according to the switching element temperature. That is, the current flowing through the switching elements Q1, Q4, and Q6 is limited to the allowable current or less.

Therefore, the capacitor discharge control stops the switching elements Q1, Q4, and Q6 from being damaged (thermal breakdown or the like). In addition, even in the case where the capacitor discharge command is erroneously input to the controller 55 when the battery VB, the first capacitor 51, and the second capacitor 21 are in an electrically connected state, it is possible to stop the switching elements Q1, Q4, and Q6 from being damaged (thermal breakdown or the like).

The controller 55 is configured to control the switching elements Q1, Q4, and Q6 such that the current flowing through the switching elements Q1, Q4, and Q6 becomes equal to or more than the lower limit current according to the requested discharge time and the switching element temperature during the capacitor discharge control. The lower limit current is a current necessary to complete the discharge of the first capacitor 51 and the second capacitor 21 within the requested discharge time. Therefore, it is possible to complete the discharge of the first capacitor 51 and the second capacitor 21 within the requested discharge time while stopping the switching elements Q1, Q4, and Q6 from being damaged (thermal breakdown or the like).

Specifically, in the present embodiment, the controller 55 is configured to set a target discharge current that is the allowable current or less and the lower limit current or more based on the switching element temperature, set a duty ratio of the switching elements Q1, Q4, and Q6 based on the set target discharge current and the capacitor discharge current detected by the current detector 54, and control the switching elements Q1, Q4, and Q6 at the set duty ratio. As a result, it is possible to stably perform the capacitor discharge control capable of stopping damage (thermal breakdown or the like) of the switching elements Q1, Q4, and Q6 and completing the discharge of the first capacitor 51 and the second capacitor 21 within the requested discharge time.

In the foregoing embodiment, the controller 55 performs the capacitor discharge control by controlling the switching elements Q1, Q4, and Q6. However, the present invention is not limited to this. The first capacitor 51 and the second capacitor 21, and the coil (U-phase coil, V-phase coil, and W-phase coil) of the electric motor 2 only have to be energized, and the controller 55 can perform the capacitor discharge control by controlling an arbitrary switching element among the switching elements Q1 to Q6.

In the foregoing embodiment, the controller 55 sets a target discharge current that is equal to or less than the allowable current and equal to or more than the lower limit current based on the switching element temperature. However, the present invention is not limited to this. In the case where the requested discharge time is not set or in the case where the requested discharge time is sufficiently long, the controller 55 only has to simply set the target discharge current equal to or less than the allowable current based on the switching element temperature.

In the foregoing embodiment, the controller 55 sets, as the target discharge current, a current having a current value relatively close to the lower limit current based on the switching element temperature. However, the present invention is not limited to this. For example, in the case where priority is given to shortening of the discharge time, the controller 55 may set a current having a current value relatively close to the allowable current as the target discharge current based on the switching element temperature. In addition, in the case where the suppression of the heat generation of switching elements Q1, Q4, and Q6 and the shortening of the discharge time are balanced, the controller 55 may set the current having the intermediate current value between the allowable current and the lower limit current as the target discharge current based on the switching element temperature.

In the foregoing embodiment, the controller 55 starts the capacitor discharge control by controlling the switching elements Q1, Q4, and Q6 at a duty ratio of 50% (step 5 in FIG. 4). In other words, the initial value of the duty ratio of the switching elements Q1, Q4, and Q6 when the capacitor discharge control is performed is set to 50%. However, the present invention is not limited to this. The controller 55 can start the capacitor discharge control by controlling the switching elements Q1, Q4, and Q6 at (an initial value of) an arbitrary duty ratio. For example, the controller 55 may start the capacitor discharge control by controlling the switching elements Q1, Q4, and Q6 with (an initial value of) a duty ratio corresponding to the target discharge current set in Step S4 of FIG. 4.

Alternatively, the processing in Step S5 in FIG. 4 may be omitted, and the controller 55 may start the capacitor discharge control by controlling the switching elements Q1, Q4, and Q6 in Step S9 in FIG. 4. In this case, for example, it is preferable to suppress the overshoot and the hunting by setting the upper limit value of the duty ratio.

Furthermore, the controller 55 may monitor the capacitor voltage equivalent value, set a duty ratio based on the target discharge current and the capacitor voltage equivalent value, and control the set switching elements Q1, Q4, and Q6. In this case, for example, in FIG. 4, the processing in Step S5 is omitted, the capacitor voltage equivalent value is read in Step S6 as similar in Step S1, the processing in Step S7 is omitted, and the duty ratio is set based on the target discharge current set in Step S4 and the capacitor voltage equivalent value read in Step S6 in Step S8.

In the foregoing embodiment, the controller 55 discharges the first capacitor 51 and the second capacitor 21 by the capacitor discharge control. However, the present invention is not limited to this. The controller 55 can discharge the second capacitor 21 in the same manner as described above even in the case where the first capacitor 51 is not provided, and can discharge the first capacitor 51 in the same manner as described above even in the case where the second capacitor 21 is not provided.

As described above, the embodiment of the present invention and its modifications have been described above. However, the present invention is not limited to the foregoing embodiment and modifications, and as a matter of course, the present invention can be further modified based on the technical idea of the present invention.

### LIST OF REFERENCE SIGNS

1 Electric compressor
2 Electric Motor
3 Compression mechanism
4 Main housing
5 Inverter device
6 Inverter housing
20 Connector
21 Second capacitor
50 Inverter circuit
51 First capacitor
52 Temperature detector
53 Voltage detector
54 Current detector
55 Controller
56P Positive bus bar
56N Negative bus bar
Q1 to Q6 Switching element
VB In-vehicle battery

1. A vehicle electric compressor comprising, in a housing, an electric motor, a compression mechanism driven by the electric motor, and an inverter device that supplies electric power to the electric motor, wherein
the inverter device includes:
an inverter circuit that includes a plurality of switching elements disposed between a positive bus bar and a negative bus bar connected to a DC power source of a vehicle, the inverter circuit converting DC power from the DC power source of the vehicle into AC power and supplying the AC power to a coil of the electric motor;
a capacitor connected between the positive bus bar and the negative bus bar, the capacitor being disposed closer to the DC power source of the vehicle from the inverter circuit;
a temperature detector that detects a temperature of the plurality of switching elements or a temperature in a vicinity of the plurality of switching elements; and
a controller that controls at least some of the plurality of switching elements to perform capacitor discharge control of discharging charges accumulated in the capacitor via the at least some of the switching elements and the coil of the electric motor, the controller being configured to control the at least some switching elements such that a current flowing through the at least some switching elements becomes equal to or less than an allowable current according to a temperature detected by the temperature detector.

2. The vehicle electric compressor according to claim 1, wherein the controller is configured to control the at least some switching elements such that a current flowing through the at least some switching elements becomes equal to or larger than a lower limit current according to a requested discharge time and a temperature detected by the temperature detector during the capacitor discharge control.

3. The vehicle electric compressor according to claim 1, wherein
the inverter device includes a voltage detector that detects a potential difference between the positive bus bar and the negative bus bar between the capacitor and the inverter circuit, and
the controller performs the capacitor discharge control when the potential difference detected by the voltage detector is equal to or higher than a discharge necessary voltage.

4. The vehicle electric compressor according to claim 1, wherein
the inverter device includes a current detector that detects a discharge current of the capacitor by the capacitor discharge control, and
the controller sets a target discharge current equal to or less than the allowable current based on the temperature detected by the temperature detector, the controller sets a duty ratio of the at least some switching elements based on the target discharge current and the discharge current of the capacitor detected by the current detector, and the controller controls the at least some switching elements at the set duty ratio.

5. The vehicle electric compressor according to claim 1, wherein the controller performs the capacitor discharge control based on a capacitor discharge command from a vehicle.

6. The vehicle electric compressor according to claim 5, wherein
the vehicle electric compressor is configured to be connected to a DC power source of the vehicle via a connector, and
the controller discharges the charge accumulated in the capacitor by the capacitor discharge control, and the controller further discharges the charge accumulated in a vehicle-side capacitor disposed closer to a DC power source of the vehicle from the connector and connected in parallel to the DC power source of the vehicle.
